(19) United States
(12) Patent Application Publication
(10) Pub. No.: US 2018/0107202 A1
(43) Pub. Date: Apr. 19, 2018

(54) SYSTEM AND METHOD FOR DETECTING FAULT EVENTS

(71) Applicant: Micron Technology, Inc., Boise, ID (US)

(72) Inventors: Yueh-Cheng HSUEH, Taoyuan City (TW); Yu-Wei LIU, New Taipei City (TW); Liang-Lun LEE, Taipei City (TW); Tzu-Chiang LIN, New Taipei City (TW); Chun-Yu CHEN, New Taipei City (TW); Chia-Hung LIU, New Taipei City (TW)

(21) Appl. No.: 15/296,053

(22) Filed: Oct. 18, 2016

(51) Int. Cl. G05B 23/02; G05B 19/048

(52) U.S. Cl. CPC G05B 23/0272; G05B 2219/32222; G05B 2219/45031; G05B 19/048

(57) ABSTRACT

A detection method includes: aligning, by a processor, first data with second data according to steps, in which the first data and the second data are associated with equipment for fabricating semiconductor devices; determining, by the processor, a first virtual area according to the first data; determining, by the processor, a second virtual area according to the second data; and displaying, by a display, a result of comparing the first virtual area and the second virtual area, to distinguish whether a fault event exists during the process.

### BACKGROUND

### Technical Field

The present disclosure relates to a process control system. More particularly, the present disclosure relates to a system and a method for detecting fault events in equipment for fabricating semiconductor devices.

### Description of Related Art

In a semiconductor fabrication process, semiconductor devices are formed with sequential semiconductor layers. The semiconductor fabrication process is performed with a wide variety of processing and measuring machines. The processing machine performs various processing functions as defined, for example, by recipes for fabrication of semiconductor device.

Traditionally, fault detection and classification (FDC) matching between different tools is identified by user knowledge. For example, a user identifies an abnormal situation on a FDC chart by his or her experience and knowledge rather than a standard criterion. Furthermore, it is difficult to efficiently identify whether the abnormal situation exists in a great many processing machines simultaneously.

### SUMMARY

In some aspects, a detection method is provided. The detection method includes: aligning, by a processor, first data with second data according to steps, in which the first data and the second data are associated with equipment for fabricating semiconductor devices; determining, by the processor, a first virtual area according to the first data; determining, by the processor, a second virtual area according to the second data; and displaying, by a display, a result of comparing the first virtual area and the second virtual area, to distinguish whether a fault event exists in the equipment.

In some aspects, a computer-implemented method for detecting a fault event is provided. The computer-implemented method includes: aligning, by a processor, first data with second data at steps, in which the first data and the second data are associated with equipment for fabricating semiconductor devices; converting, by the processor, the first data and the second data into a first virtual area that is associated with the first data and a second virtual area that is associated with the second data; comparing the first virtual area with the second virtual area; and displaying, by an input/output (I/O) module, a result of comparing the first virtual area and the second virtual area via a plurality of indicators, in order to distinguish whether the fault event exists in the equipment.

As discussed above, the methods of the present disclosure improve the efficiency of monitoring fault events in a great many equipments simultaneously.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a schematic diagram of a system, in accordance with some embodiments of the present disclosure.

FIG. 2 is a flow chart illustrating operations of a method, in accordance with some embodiments of the present disclosure.

FIG. 3A is a schematic diagram of first data and second data, in accordance with some embodiments of the present disclosure.

FIG. 3B is a schematic diagram of first data and second data in FIG. 3A after being aligned, in accordance with some embodiments of the present disclosure.

FIG. 3C is a partially enlarged view of the first data D1 in FIG. 3B, in accordance with some embodiments of the present disclosure.

FIG. 3D is a schematic diagram of the first virtual area and the second virtual area, in accordance with some embodiments of the present disclosure.

FIG. 4 is a schematic diagram of threes cases of the comparison result operation in FIG. 2, in accordance with some embodiments of the present disclosure.

FIG. 5 is a schematic diagram of an interface of a monitoring tool displayed by the I/O interfaces in FIG. 1, in accordance with some embodiments of the present disclosure.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

The terms used in this specification generally have their ordinary meanings in the art and in the specific context where each term is used. The use of examples in this specification, including examples of any terms discussed herein, is illustrative only, and in no way limits the scope and meaning of the disclosure or of any exemplified term. Likewise, the present disclosure is not limited to various embodiments given in this specification.

Although the terms “first,” “second,” etc., may be used herein to describe various elements, these elements should not be limited by these terms. These terms are used to distinguish one element from another. For example, a first element could be termed a second element, and, similarly, a second element could be termed a first element, without departing from the scope of the embodiments. As used herein, the term “and/or” includes any and all combinations of one or more of the associated listed items.

In this document, the term “coupled” may also be termed as “electrically coupled,” and the term “connected” may be termed as “electrically connected”. “Coupled” and “connected” may also be used to indicate that two or more elements cooperate or interact with each other.

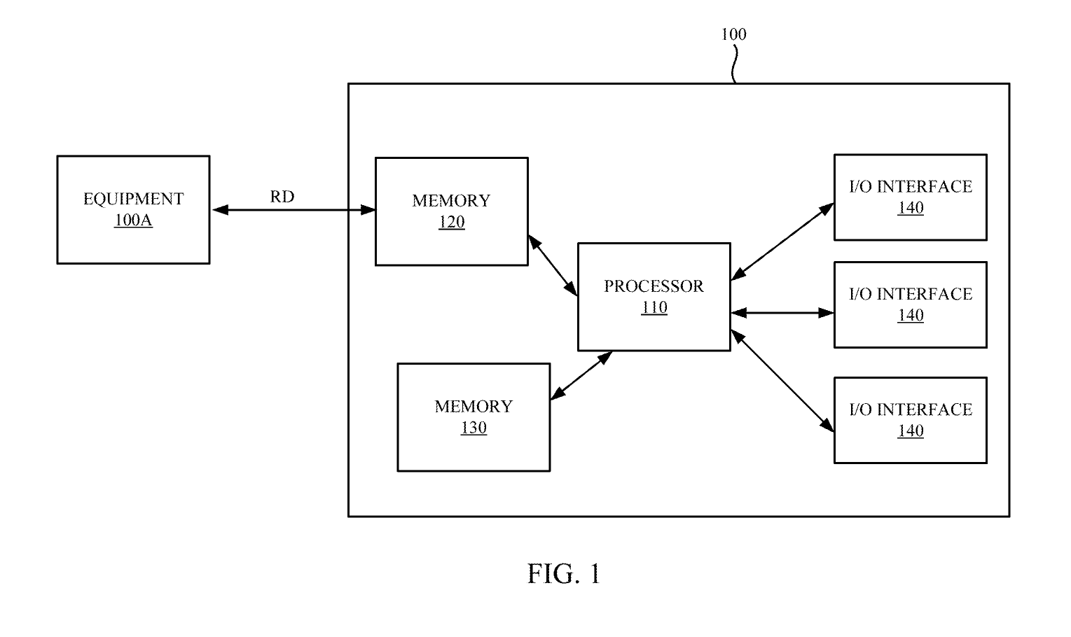

Reference is now made to FIG. 1. FIG. 1 is a schematic diagram of a system 100, in accordance with some embodiments of the present disclosure. In some embodiments, the system 100 is configured to monitor and/or control manufacturing process of semiconductor devices. In some embodiments, the system 100 is configured to detect whether a fault event exists in equipment (e.g., equipment 100A) for fabricating the semiconductor devices.

The system 100 includes a processor 110, a memory 120, a memory 130, and input/output (I/O) interfaces 140. The processor 110 is coupled to the memory 120, the memory 130, and the I/O interfaces 140. In some embodiments, the processor 110 is implemented with one or more processing units. In various embodiments, the processing units includes a central processing unit (CPU), an application specific integrated circuit (ASIC), a multi-processor, a distributed processing system, and so on. In some embodiments, the processor 110 is implemented with parallel-computing processing units. Various circuits or units to implement the processor 110 are within the contemplated scope of the present disclosure.

In various embodiments, each of the memory 120 and the memory 130 is implemented with one or more data storage units. The memory 120 is coupled to equipment 100A to receive raw data RD. Accordingly, the raw data RD are stored in the memory 120. In some embodiments, the equipment 100A is configured to perform one or more semiconductor fabrication processes on a wafer (not shown) for semiconductor fabrication. In some embodiments, the equipment 100A includes one or more semiconductor manufacturing machines. In some embodiments, one or more semiconductor fabrication processes include etching, deposition, implantation, annealing, etc. In some embodiments, one or more semiconductor manufacturing machines include photolithography steppers, etch machines, deposition machines, polishing machines, rapid thermal anneal machines, ion implantation machines, and the like.

In some embodiments, the raw data RD indicates information regarding operating parameters and/or sensing parameters of the equipment 100A. In some embodiments, the operating parameters and/or sensing parameters include voltages, currents, pressure, gas flows, time, temperature, impurity levels, and so on.

The configurations of the equipment 100A and the raw data RD mentioned above are given for illustrative purposes. Various configurations of the equipment 100A and the raw data RD are within the contemplated scope of the present disclosure. For ease of understanding, only one of the equipment 100A is illustrated in FIG. 1. Various numbers of the equipment 100A are within the contemplated scope of the present disclosure.

The memory 130 stores one or more program codes for monitoring the equipment 100A. In some embodiments, the memory 130 stores program codes encoded with a set of instructions for analyzing the raw data RD, so as to distinguish whether a fault event exists in the equipment 100A. In some embodiments, the term “fault event” indicates that the current operating condition of the equipment 100A is different from what is usual or expected. For illustration, in some embodiments, a fault detection and classification (FDC) tool (not shown) is implemented in a form of program codes which are stored in the memory 130 and encoded with a set of instructions. The processor 110 executes the FDC tool to analyze the raw data RD, in order to detect the fault event.

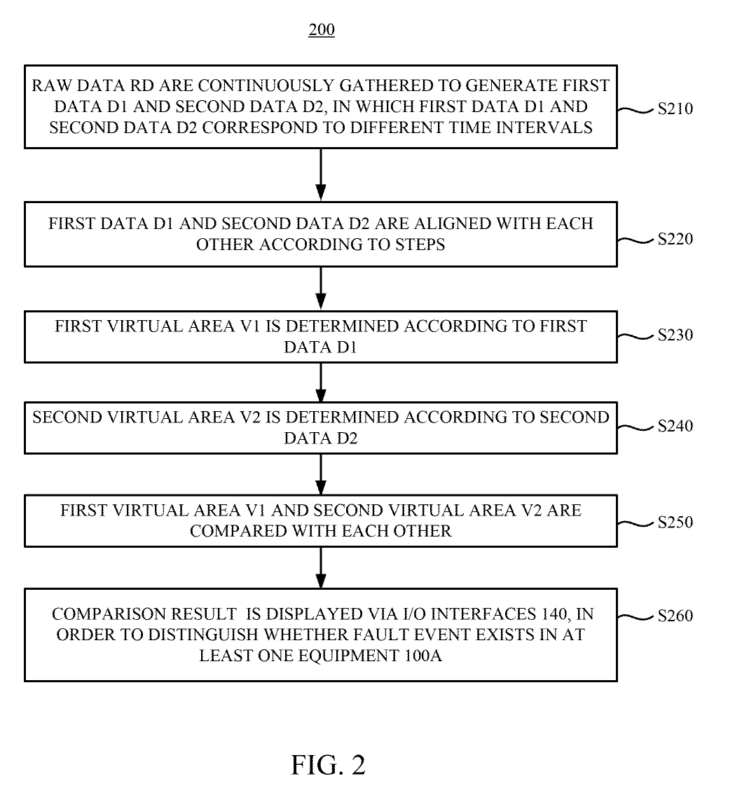

In some embodiments, the memory 130 is a non-transitory computer readable storage medium encoded with, i.e., storing, a set of executable instructions. For illustration, the memory 130 stores executable instructions for performing operations including, for example, operations S210, S220, S230, S240 and S250 illustrated in FIG. 2. In some embodiments, the computer readable storage medium is an electronic, magnetic, optical, electromagnetic, infrared, and/or a semiconductor system (or apparatus or device). For example, the computer readable storage medium includes a semiconductor or solid-state memory, a magnetic tape, a removable computer diskette, a random access memory (RAM), a read-only memory (ROM), a rigid magnetic disk, and/or an optical disk.

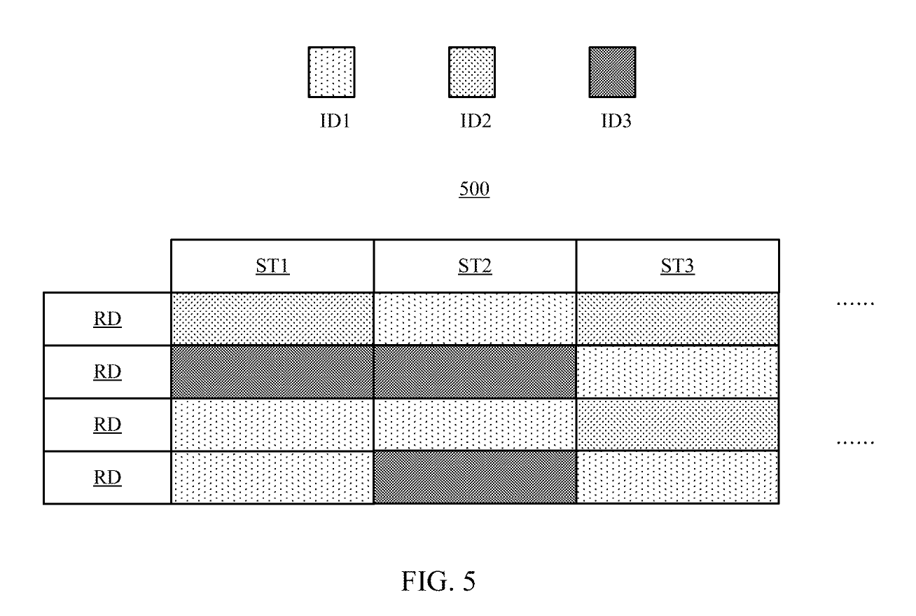

The I/O interfaces 140 receive inputs or commands from various control devices (not shown), which, for example, are operated by a process engineer and/or a maintenance engineer. Accordingly, the system 100 is able to be operated with the commands or recipe received by the I/O interfaces 140. In some embodiments, the I/O interfaces 140 include a display configured to display the status of executing the program codes. In some embodiments, the I/O interfaces 140 include a display configured to display a result of analyzing the raw data RD, as illustrated in FIG. 5 below. In some embodiments, the I/O interfaces 140 include a graphical user interface (GUI). In some other embodiments, the I/O interfaces 140 include a keyboard, keypad, mouse, trackball, track-pad, touch screen, cursor direction keys, or the combination thereof, for communicating information and commands with the processor 110.

Reference is now made to FIG. 2. FIG. 2 is a flow chart illustrating operations of a method 200, in accordance with some embodiments of the present disclosure. In some embodiments, the method 200 is implemented with a tool carried in the system 100 in FIG. 1. In some embodiments, the method 200 is implemented with software that is executable on the processor 110 in FIG. 1 to detect the fault event in the equipment 100A.

In operation S210, the raw data RD are continuously gathered to generate first data D1 and second data D2, in which the first data D1 and the second data D2 correspond to different time intervals.

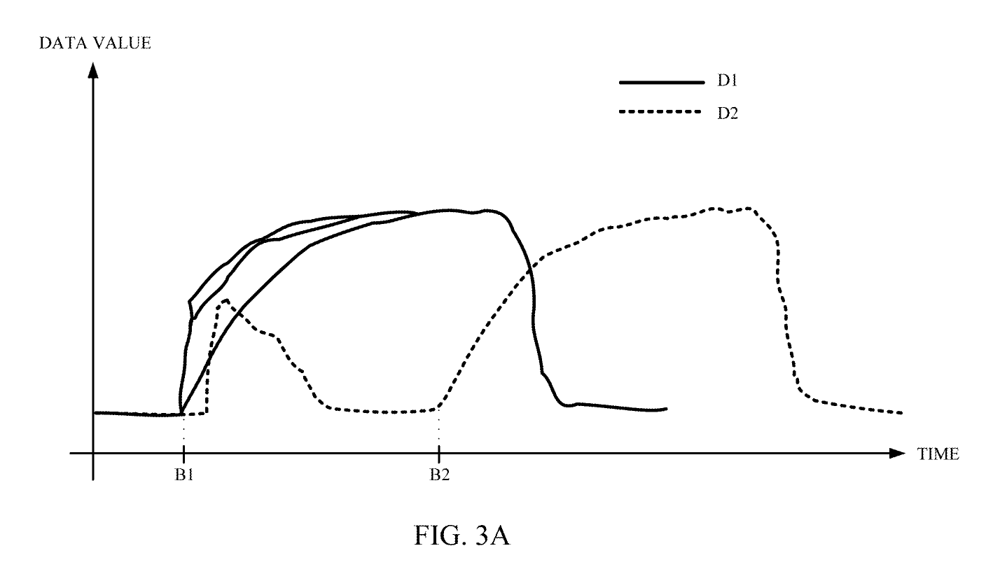

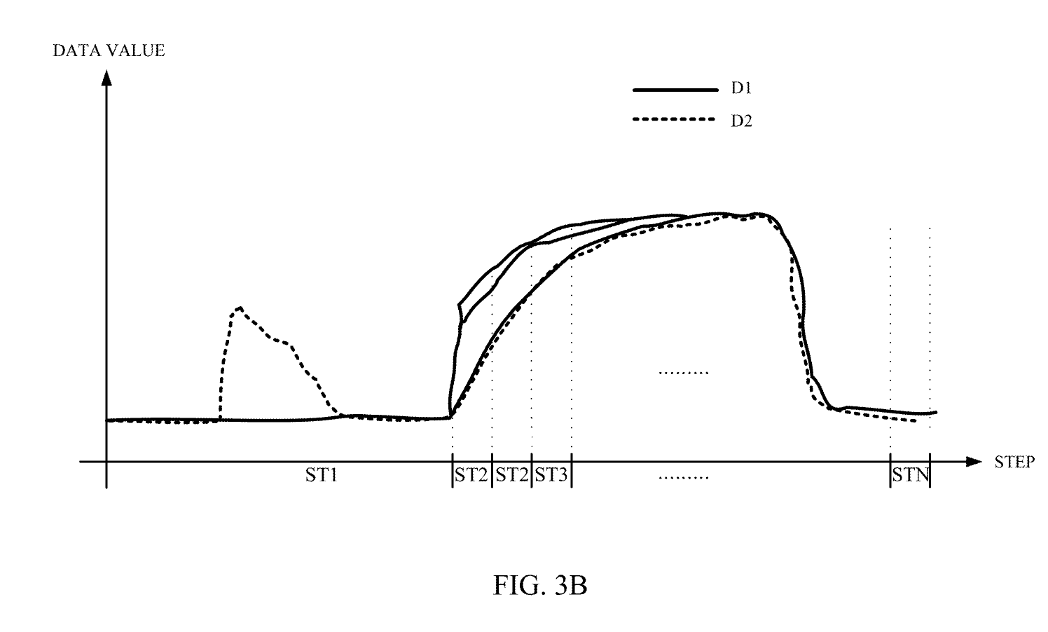

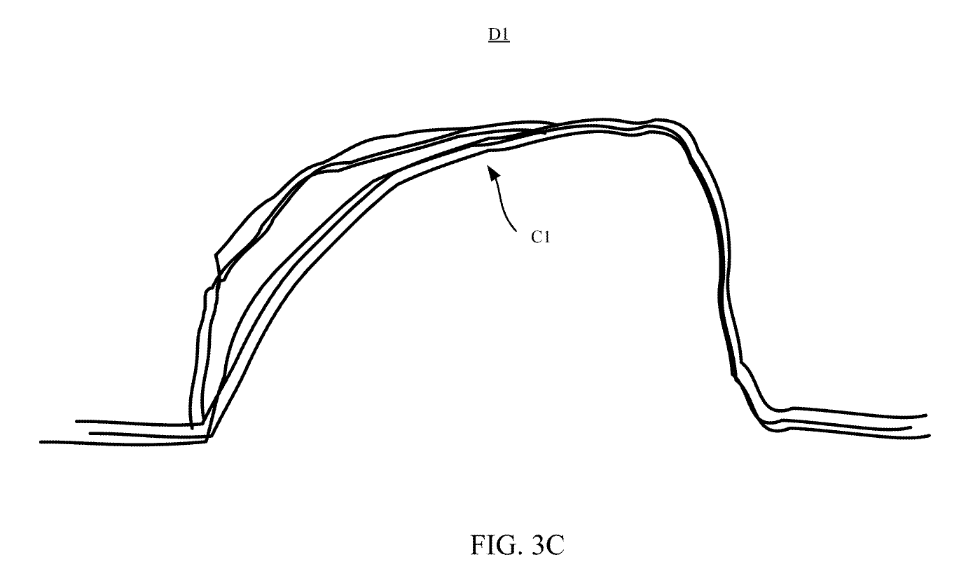

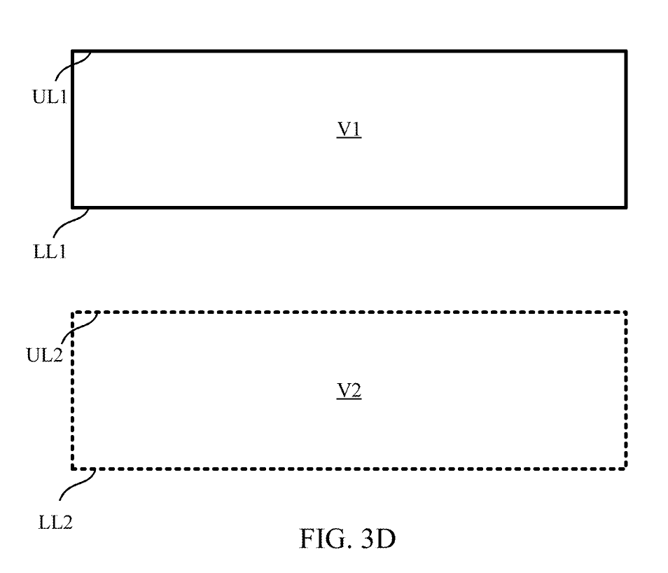

Reference is now made to FIG. 3A. FIG. 3A is a schematic diagram of the first data D1 and the second data D2, in accordance with some embodiments of the present disclosure. As described above, the raw data RD are able to be analyzed by the FDC tool. In some embodiments, the raw data RD are gathered during a predetermined time interval, and then processed by the FDC tool to generate first data D1, as illustrated in FIG. 3A. In some embodiments, the predetermined time interval is a period for gathering the raw data RD. In some embodiments, the predetermined time interval is configured to be about 24 hours. For example, the first data D1 correspond to the raw data RD that are gathered in first 24 hours, and the second data D2 correspond to the raw data RD that are gathered in second (i.e., next) 24 hours.

The amount of the predetermined time interval given above is for illustrative purposes only. Various amounts of the predetermined time interval are within the contemplated scope of the present disclosure. For ease of understanding, the first data D1 and the second data D2 are illustrated in a form of a curve which indicates the response of the equipment 100A relative to the an external command or a recipe. Various forms of the first data D1 and the second data D2 are within the contemplated scope of the present disclosure.

With continued reference to FIG. 2, in operation S220, the first data D1 and the second data D2 are aligned with each other according to steps.

As shown in FIG. 3A, the first data D1 and the second data D2 are dislocated at different times. In some embodiments, in order to detect whether the fault event exists, the first data D1 and the second data D2 are aligned with each other according to steps. In some embodiments, the term “step” indicates a process step time that corresponds to a segment of the first data D1 and/or the second data D2.

Reference is now made to FIG. 3B. FIG. 3B is a schematic diagram of first data D1 and second data D2 in FIG. 3A after being aligned, in accordance with some embodiments of the present disclosure. In some embodiments, the first data D1 and the second data D2 are aligned, by the processor 110, step by step. In some embodiments, as shown in FIG. 3B, the first data D1 and the second data D2 are aligned with each other at each step ST1-STN, in which N is an integer that greater than 1. In other words, the first data D1 and the second data D2 are virtually arranged by a sequence of the steps ST1-STN. In some embodiments, the term “virtual” indicates that the areas (e.g., V1 and V2 in FIG. 3D) discussed in the present disclosure are generated by a series of data-processing and/or data computations.

In some other embodiments, operation S220 is performed without considering data gathered at the first step ST1. Alternatively stated, in such embodiments, the first data D1 and the second data D2 are aligned with each other at each step ST2-STN, in which N is an integer that greater than 2. In some embodiments, the step ST1 indicates a buffering time or precondition time for the equipment 100A to respond to an external command or a recipe. In some situations, during the buffering time, the equipment 100A is preparing to perform the semiconductor fabrication processes on a wafer (not shown). For example, as shown in FIG. 3A, the buffering time of the first data D1 is labeled as “B1”, and the buffering time of the second data D2 is labeled as “B2”. After the buffering times B1-B2 is passed, the semiconductor fabrication processes are performed on the wafer. Accordingly, segments of the first data D1 and those of the second data D2, which correspond to the buffering times B1-B2, are insufficient to reflect the real operating conditions and/or sensing parameters of the equipment 100A. In order to increase accuracy and efficiency of detecting the fault events in the situations discussed above, in operation S220, the first data D1 and the second data D2 are virtually aligned with each other at each step ST2-STN, except the step ST1.

With continued reference to FIG. 2, in operation S230, a first virtual area V1 is determined according to the first data D1. In operation S240, a second virtual area V2 is determined according to the second data D2. The operations S230-S240 are explained with reference to FIGS. 3C and 3D below.

Reference is now made to FIG. 3C. FIG. 3C is a partially enlarged view of the first data D1 in FIG. 3B, in accordance with some embodiments of the present disclosure. As described above, the first data D1 and the second data D2 are generated according to the raw data RD that are gathered during the predetermined time interval. Accordingly, each of the first data D1 and the second data D2 in FIG. 3B includes a certain amount of information. For example, as shown in FIG. 3C, the first data D1 includes a certain amount of information, which is illustrated as multiple curves C1. In some embodiments, an upper limit value (e.g., UL1 in FIG. 3D below) and a lower limit value (e.g., LL1 in FIG. 3D below) are present in the multiple curves C1 of the first data D1.

In some embodiments, the processor 110 is able to analyze the first data D1 in FIG. 3B to determine the upper limit value and a lower limit value of the first data D1. In some embodiments, the upper limit value of the first data D1 is set to be a maximum value of the multiple curves C1, and the lower limit value of the first data D1 is set to be a minimum value of the multiple curves C1. In some other embodiments, the upper limit value of the first data D1 is predetermined times as large as a maximum value of the multiple curves C1, and the lower limit value of the first data D1 is predetermined times as large as a minimum value of the multiple curves C1. In some embodiments, the value of the predetermined times is able to be adjusted according practical requirements. With the conversion from the multiple curves C1 to the upper limit value and the lower limit value, the first data D1 are compressed. As a result, the data amount for detecting the fault event is significantly reduced.

Reference is now made to FIG. 3D. FIG. 3D is a schematic diagram of the first virtual area V1 and the second virtual area V2, in accordance with some embodiments of the present disclosure. In some embodiments, the upper limit value and the lower limit value of the first data D1 are utilized to determine the first virtual area V1. In some embodiments, the first virtual area V1 is configured to have a predetermined length, and a width of the first virtual area is determined by a difference between an upper limit value UL1 and a lower limit value LL1. Accordingly, as shown FIG. 3D, the first virtual area V1 is determined by the upper limit value UL1 and the lower limit value LL1 of the first data D1. With this analogy, the second virtual area V2 is also able to be determined by an upper limit value UL2 and a lower limit value LL2 of the second data D2 in FIG. 3D. With operations S230 and S240, the first data D1 and the second data D2 in FIG. 3B, which are presented in one-dimensional space (i.e. curves), are converted into the first virtual area V1 and the second virtual area V2 in FIG. 3D, which are presented in two-dimensional space (i.e. planes). Accordingly, it is more efficient to detect differences between the first data V1 and the second data V2 in FIG. 3B by comparing the first virtual area V1 and the second virtual area V2 in FIG. 3D.

The determination process of the first virtual area V1 and the second virtual area V2 are given for illustrative purposes only. Various determination processes of the first virtual area V1 and the second virtual area V2 are within the contemplated scope of the present disclosure. Taking the first virtual area V1 as an example, in some other embodiments, the processor 110 performs an integral operation according to the first data D1, the upper limit value UL1, and the lower limit value LL1 to generate the first virtual area V1.

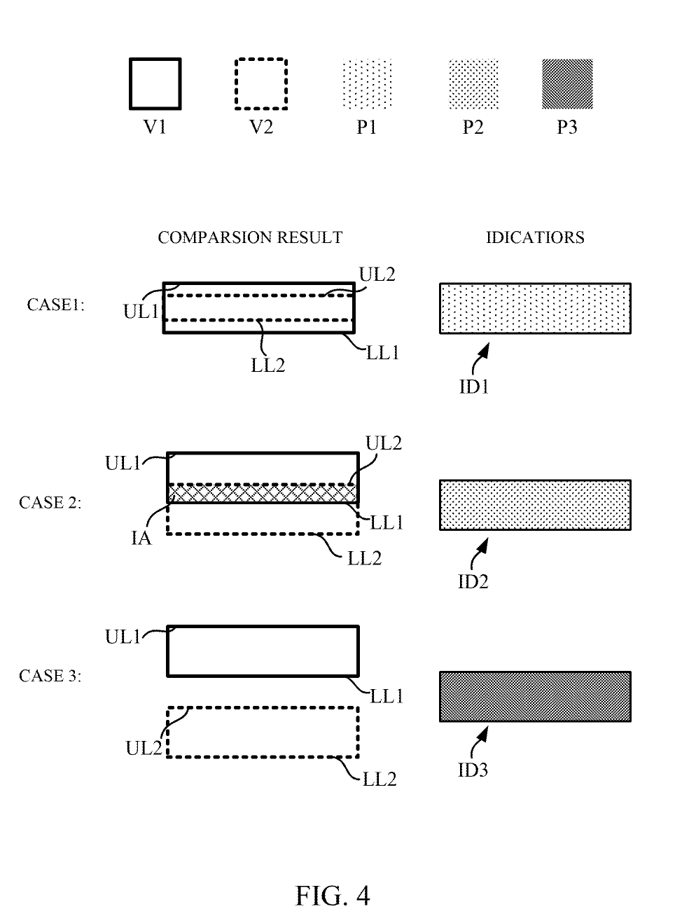

With continued reference to FIG. 2, in operation S250, the first virtual area V1 and the second virtual area V2 are compared with each other. In operation S260, the comparison result is displayed via the I/O interfaces 140, in order to distinguish whether the fault event exists in the equipment 100A. In some embodiments, a fault event is detected based on a correlation between the first virtual area V1 and the second virtual area V2 in FIG. 3D. The detailed explanations to operations S250 and S260 are given with reference to FIGS. 4-5 below.

Reference is now made to FIG. 4. FIG. 4 is a schematic diagram of threes cases of the comparison result in operation S250 in FIG. 2, in accordance with some embodiments of the present disclosure.

In some embodiments, to perform operation S250, the processor 110 compares the upper limit value UL1 and the lower limit value LL1 with the upper limit value UL2 and the lower limit value LL2. For example, as shown in FIG. 4, the comparison result of these limit values is sorted into three cases. In case 1, the upper limit value UL2 is less than the upper limit value UL1, and the lower limit value LL2 is greater than the lower limit value LL1. Accordingly, the second virtual area V2 is determined to be within the first virtual area V1. Under this condition, it indicates that the raw data RD that are gathered in first 24 hours are substantially the same as raw data RD that are gathered in the next 24 hours. As a result, it is determined that there is no fault events exist in the equipment 100A. In some embodiments, an indicator ID1 is configured to be displayed as a first color pattern P1, in a condition that the case 1 is determined.

Furthermore, in case 2, the upper limit value UL2 is between the upper limit value UL1 and the lower limit value LL1, and the lower limit value UL2 is less than the lower limit value UL1. Accordingly, the second virtual area V2 is determined to be partially overlapped with the first virtual area V1. Under this condition, it indicates that a difference is present between the raw data RD gathered in first 24 hours and the raw data RD gathered in the next 24 hours. In some embodiments, it is determined that there is a fault events exist in the equipment 100A, in a condition that an intersection area IA between the second virtual area V2 and the first virtual area V1 is larger than a predetermined area. In some embodiments, the predetermined area is set according to practical requirements, which includes, for example, tolerance of variation, process accuracy, etc. In some embodiments, an indicator ID2 is configured to be displayed as a second color pattern P2, in a condition that the case 2 is determined.

Moreover, in case three, both of the upper limit value UL2 and the lower limit value UL2 are less than the lower limit value UL1. Accordingly, the second virtual area V2 is separated from the first virtual area V1. Under this condition, it indicates that a huge difference is present in the raw data RD gathered in first 24 hours and the raw data RD gathered in next 24 hours. As a result, it is determined that there is a fault event existing in the equipment 100A. In some embodiments, an indicator ID3 is configured to be displayed as a third color pattern P3, in a condition that the case 3 is determined.

In some embodiments, the first color pattern P1, the second color pattern P2, and the third color pattern P3 are assigned to different colors. For example, colors that are assigned to the first color pattern P1, the second color pattern P2, and the third color pattern P3 are getting darker. With such an arrangement, it will be more efficient to distinguish whether a fault event exists.

The arrangements of the first color pattern P1, the second color pattern P2, and the third color pattern P3 given above are for illustrative purposes only. Various arrangements of the first color pattern P1, the second color pattern P2, and the third color pattern P3 are within the contemplated scope of the present disclosure.

Reference is now made to FIG. 5. FIG. 5 is a schematic diagram of an interface 500 of a monitoring tool displayed by the I/O interfaces 140, in accordance with some embodiments of the present disclosure.

In some embodiments, the processor 100 performs a monitoring tool (not shown) carried in the memory 130, to display the comparison results of the first virtual area V1 and the second virtual area V2 through the I/O interface 140. For example, as shown in FIG. 5, the interface 500 of the monitoring tool illustrates information regarding parameters in the raw data RD and the indicators ID1-ID3 discussed in FIG. 4 at each step ST1-STN. In some embodiments, the layout of the interface 500 is arranged similar with a chessboard. In some embodiments, the indicators ID1-ID3 are arranged in rows and columns. In some embodiments, the rows of the indicators ID1-ID3 correspond to different parameters in the raw data RD. As discussed above, the indicators ID1-ID3 are displayed with different color patterns. With the arrangements of the indicators ID1-ID3 with the interface 500, it is convenient to monitor fault events in a great many equipments 100A simultaneously. The indicators ID2 and ID3 are displayed with color patterns, which are different from the color pattern corresponding to the indicator ID1. Accordingly, it is able to distinguish whether fault events exist more efficiently.

One of ordinary skill in the art would recognize that an order of operations in the method 200 in FIG. 2 is adjustable. One of ordinary skill in the art would further recognize that additional operations are able to be included in the method 200 without departing from the scope of the present disclosure.

In some embodiments, the term “tool” can be implemented as software carried in the memory 130 in FIG. 1, and is executable by the processor 110 to perform the method 200 in FIG. 2.

In some embodiments, the method 200 in FIG. 2 is implemented in the form of a computer program product stored on a computer-readable storage medium having computer-readable instructions embodied in the medium.

As discussed above, the system 100 and the method 200 of the present disclosure improve the efficiency of monitoring fault events in a great many equipments simultaneously.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A detection method, comprising:
aligning, by a processor, first data with second data according to a plurality of steps, wherein the first data and the second data are associated with equipment for fabricating semiconductor devices;
determining, by the processor, a first virtual area according to the first data;
determining, by the processor, a second virtual area according to the second data; and
displaying, by a display, a result of comparing the first virtual area and the second virtual area, to distinguish whether a fault event exists in the equipment.

2. The detection method of claim 1, wherein the first data and the second data are gathered at each of the steps, and the operation of aligning the first data with the second data comprises:
aligning the first data with the second data at the steps.

3. The detection method of claim 1, wherein the operation of determining the first virtual area comprises:
determining a first upper limit value and a first lower limit value according to the first data; and
generating the first virtual area according to the first upper limit value and the first lower limit value.

4. The detection method of claim 3, wherein the first upper limit value is predetermined times as large as a maximum value of the first data, and the first lower limit value is the predetermined times as large as a minimum value of the first data.

5. The detection method of claim 3, wherein the operation of determining the second virtual area comprises:
determining a second upper limit value and a second lower limit value according to the second data; and
generating the second virtual area according to the second upper limit value and the second lower limit value.

6. The detection method of claim 5, wherein the second upper limit value is predetermined times as large as a maximum value of the second data, and the second lower limit value is the predetermined times as large as a minimum value of the second data.

7. The detection method of claim 5, wherein the operation of displaying the result of comparing the first virtual area and the second virtual area comprises:
comparing, by the processor, the first upper limit value and the first lower limit value with the second upper limit value and the second lower limit value; and
displaying, by the display, the result of comparing the first area with the second area with a plurality indicators that are displayed with different color patterns.

8. The detection method of claim 7, wherein a first indicator of the indicators is displayed for indicating that there is no fault events, in a condition that the second upper limit value is less than the first upper limit value, and the second lower limit value is greater than the first lower limit value.

9. The detection method of claim 7, wherein a second indicator of the indicators is displayed for indicating that the fault event exists in the equipment, in a condition that the second upper limit value is between the first upper limit value and the first lower limit value, the second lower limit value is less than the first lower limit value, and an intersection area between the first virtual area and the second virtual area is larger than a predetermined area.

10. The detection method of claim 7, wherein a third indicator of the indicators is displayed for indicating that the fault event exists in the equipment, in a condition that both of the second upper limit value and the second lower limit value are less than the first lower limit value.

11. A computer-implemented method for detecting a fault event, comprising:
aligning, by a processor, first data with second data at a plurality of steps, wherein the first data and the second data are associated with equipment for fabricating semiconductor devices;
converting, by the processor, the first data and the second data into a first virtual area that is associated with the first data and a second virtual area that is associated with the second data;
comparing the first virtual area with the second virtual area; and
displaying, by an input/output (I/O) module, a result of comparing the first virtual area and the second virtual area via a plurality of indicators, in order to distinguish whether the fault event exists in the equipment.

12. The computer-implemented method of claim 11, wherein the first data and the second data are gathered at each of the steps.

13. The computer-implemented method of claim 11, wherein the operation of converting the first data and the second data comprises:
determining a first upper limit value and a first lower limit value according to the first data;
generating the first virtual area according to the first upper limit value and the first lower limit value;
determining a second upper limit value and a second lower limit value according to the second data; and
generating the second virtual area according to the second upper limit value and the second lower limit value.

14. The computer-implemented method of claim 13, wherein the first upper limit value is a predetermined times as large as a maximum value of the first data, and the first lower limit value is the predetermined times as large as a minimum value of the first data.

15. The computer-implemented method of claim 13, wherein the second upper limit value is predetermined times as large as a maximum value of the second data, and the second lower limit value is the predetermined times as large as a minimum value of the second data.

16. The computer-implemented method of claim 11, wherein the operation of comparing the first virtual area with the second virtual area:
comparing, by the processor, the first upper limit value and the first lower limit value with the second upper limit value and the second lower limit value.

17. The computer-implemented method of claim 16, wherein the operation of the displaying the result of comparing the first virtual area and the second virtual area comprises:
displaying a first indicator of the indicators to indicate that there is no fault event, in a condition that the second upper limit value is less than the first upper limit value, and the second lower limit value is greater than the first lower limit value.

18. The computer-implemented method of claim 17, further comprises:
displaying a second indicator of the indicators to indicate that the fault event exists in the equipment, in a condition that the second upper limit value is between the first upper limit value and the first lower limit value, the second lower limit value is less than the first lower limit value, and an intersection area between the first virtual area and the second virtual area is larger than a predetermined area.

19. The computer-implemented method of claim 18, further comprises:
displaying a third indicator of the indicators to indicate that the fault event exists in the equipment, in a condition that both of the second upper limit value and the second lower limit value are less than the first lower limit value.

20. The computer-implemented method of claim 11, wherein the indicators are displayed with different color patterns.
